(19) United States
(12) Patent Application Publication
(10) Pub. No.: US 2013/0176603 A1
(43) Pub. Date: Jul. 11, 2013

(54) Backlit Scanner System and Method

(71) Applicant: Alfred M. Bernstein, Lynbrook, NY (US)

(72) Inventor: Alfred M. Bernstein, Lynbrook, NY (US)

(21) Appl. No.: 13/735,839

(22) Filed: Jan. 7, 2013

Related U.S. Application Data
(60) Provisional application No. 61/583,726, filed on Jan. 6, 2012.

(51) Int. Cl. H04N 1/028

(52) U.S. Cl. CPC H04N 1/02815
USPC 358/475

(57) ABSTRACT

A backlit scanner uses an exposure control device to adjust the amount of backlight that reaches the vicinity of the transmissive medium being scanned by the scanner. In this way, the amount of backlight can be controlled on a scan-by-scan basis, depending upon exactly how much backlight will lead to optimal image quality. In some preferred embodiments the backlit scanner is designed to scan x-ray images and/or other transmissive-medium medical images.

### REFERENCE TO RELATED APPLICATION

This application claims the benefit of U.S. Provisional Patent Application No. 61/583,726 filed Jan. 6, 2012, which is herein incorporated by reference in its entirety.

### BACKGROUND OF THE INVENTION

1. Field of the Invention

The present invention relates to a backlight assembly and a backlit scanner and more particularly to a backlight assembly and a backlit scanner used for imaging purposes and methods thereof.

2. Description of the Related Art

U.S. Pat. No. 6,494,586 to Huang et al. (“'586 Huang”) (Figure and/or reference numerals in this paragraph refer to the '586 Huang document) discloses a back-light module 3 of an image scanning device 1 (see FIG. 3). A reflective sheet 33, a light guide plate 34, a diffusion plate 35, and a focusing plate 36, are sequentially arranged in a casing 31 of the back-light module 3 (see FIG. 4). Light generated by tubular lamps 41, 42 is guided and spread uniformly over the light guide plate 34 (see FIG. 6). '586 Huang discloses that light projected from light guide plate 34 is further distributed by the diffusion plate 35 to obtain a uniform light over the area of the backlit footprint. (See '586 Huang at col. 3, line 34 through col. 4, line 13.) Therefore, '586 Huang does not disclose that the diffusion plate reduces the amount of light from the backlight(s) that actually reaches the transmissive medium being scanned. In other words, '586 Huang does not disclose any sort of “exposure control.” '586 Huang also does not disclose that the diffusion plate can be removed and replaced from the body of the scanner or suggest any reason for doing so. Such a feature would defeat the goal of providing uniformly distributed light focused on the transmissive medium being scanned. There would be little point in removing or reconfiguring a plate that provides uniformly distributed light, as does the diffusion plate of '586 Huang. '586 Huang is more interested in uniform light distribution than in the magnitude of the intensity of the effective backlighting that reaches the transmissive medium being scanned. '586 Huang is silent on disclosing or suggesting lessening or brightening the amount of light on the subject so as to control a desired exposure on a scanner camera imaging device.

The following published document(s) may also include helpful background information: (i) U.S. Pat. No. 7,808,688 to Neushul (“'688 Neushul”) relates to an apparatus and method for capturing images, such as digital images, from alternative media types, such as transmissive film and reflective filmless plates. A laser or other source of excitation radiation is coupled to a mounting surface in optical communication with a reading window when installed on a scanner. A rear casing is coupled to the monitoring surface to engage the housing of the scanner, the housing defining the reading window. (See Field and Brief Summary of the Invention sections of '688 Neushul.)

### BRIEF SUMMARY OF THE INVENTION

In accordance with one aspect of the present invention there is provided a backlit scanner system for scanning images printed on a transmissive medium, the scanner includes a scanner to create an image based on light received from the transmissive medium when the transmissive medium is scanned; and a backlight assembly positioned on the scanner to backlight the transmissive medium, the assembly comprising a light source and an exposure control device which enables the user to adjust the intensity of the light source to optimize the quality of the scanned image.

In accordance with another aspect of the present invention there is provided a backlight assembly including a light source and an exposure control device which enables the user to adjust the intensity of the light source transmitted from the backlight assembly.

In accordance with another aspect of the present invention there is provided a method of scanning an image on a transmissive medium including (a) providing a backlit scanner including a scanner to create an image based on light received from the transmissive medium when the transmissive medium is scanned; and a backlight assembly positioned on the scanner to backlight the transmissive medium, the assembly including a light source and an exposure control device which enables the user to adjust the intensity of the light source to optimize the quality of the scanned image; (b) placing a transmissive medium including an image in the scanner; (c) performing a preliminary scan on the transmissive medium to obtain preliminary scanning results; (d) subsequent to step (c), adjusting the exposure control device to control the amount of backlighting, in response to observed preliminary scanning results; and (e) subsequent to step (d), performing a re-scan on the transmissive medium.

These and other objects of the present invention will become apparent upon a review of the following detailed description and the claims appended thereto.

### BRIEF DESCRIPTION OF THE DRAWINGS

The present invention will be more fully understood and appreciated by reading the following Detailed Description in conjunction with the accompanying drawings, in which:

FIG. 1 is a perspective view showing a backlight assembly including an exposure control device and a light unit attached to a scanner in accordance with an embodiment of the present invention;

FIG. 2 is a side view showing a backlight assembly having an exposure control device in accordance with an embodiment of the present invention;

FIG. 3 is a perspective view showing an exposure control device of a backlight assembly in accordance with an embodiment of the present invention;

FIG. 4 is a perspective view showing a backlight assembly in accordance with an embodiment of the present invention;

FIG. 5 is a side view showing a backlight assembly having an exposure control device in accordance with an embodiment of the present invention;

FIG. 6 is a bottom plan view showing a backlight assembly having an exposure control device in accordance with an embodiment of the present invention;

FIG. 7 is a side view showing a backlit scanner system in accordance with an embodiment of the present invention; and

FIG. 8 is a side view showing a backlit scanner system in accordance with an embodiment of the present invention.

### DETAILED DESCRIPTION OF THE INVENTION

The backlit scanner system 200 and methods of the present invention are suitable to convert analog x-ray film to digital pictures, for example, for dental or medical use. The present invention is directed to a backlit scanner 220 and backlight assembly 210 including an exposure control device 230. The exposure control device is structured, connected, located, sized and/or shaped to adjust the intensity of the backlight reaching the transmissive medium being scanned. The desired amount of light (see DEFINITIONS section) transmitted may be controlled by adjusting the exposure control device of the backlight assembly. Suitable exposure control devices include a variable resistor known to those in the art, such as a rheostat.

A backlit scanner uses an exposure control device of the backlight assembly to control the amount of backlight that reaches the vicinity of the transmissive medium being scanned by the scanner. The backlit scanner system includes a scanner 270 and a backlight assembly that variably adjusts the intensity of the backlight. Suitable scanners include those know in the art which are useful as backlit scanners. In this way, the amount of backlight can be controlled on a scan-by-scan basis, depending upon exactly how much backlight will lead to optimal image quality. In some preferred embodiments the backlit scanner is designed to scan x-ray images and/or other transmissive-medium medical images.

The backlit scanner scans images printed on a transmissive medium, the backlit scanner is designed to be used with the exposure control device; the scanner includes a scanning sub-assembly structured, located and/or connected to create an image based on reflected and/or transmitted light received from the transmissive medium when the medium is being scanned; a backlight assembly structured, located, connected, sized and/or shaped to backlight the transmissive medium; and an exposure control device for adjusting the intensity of the backlighting when the transmissive medium is being scanned.

One embodiment includes a method of scanning an image where (a) a preliminary scan is done on a transmissive medium; (b) subsequent to step (a), the exposure control device is adjusted by the user, to control the amount of backlighting, in response to observed preliminary scanning results; and (c) subsequent to step (b), a re-scan is done.

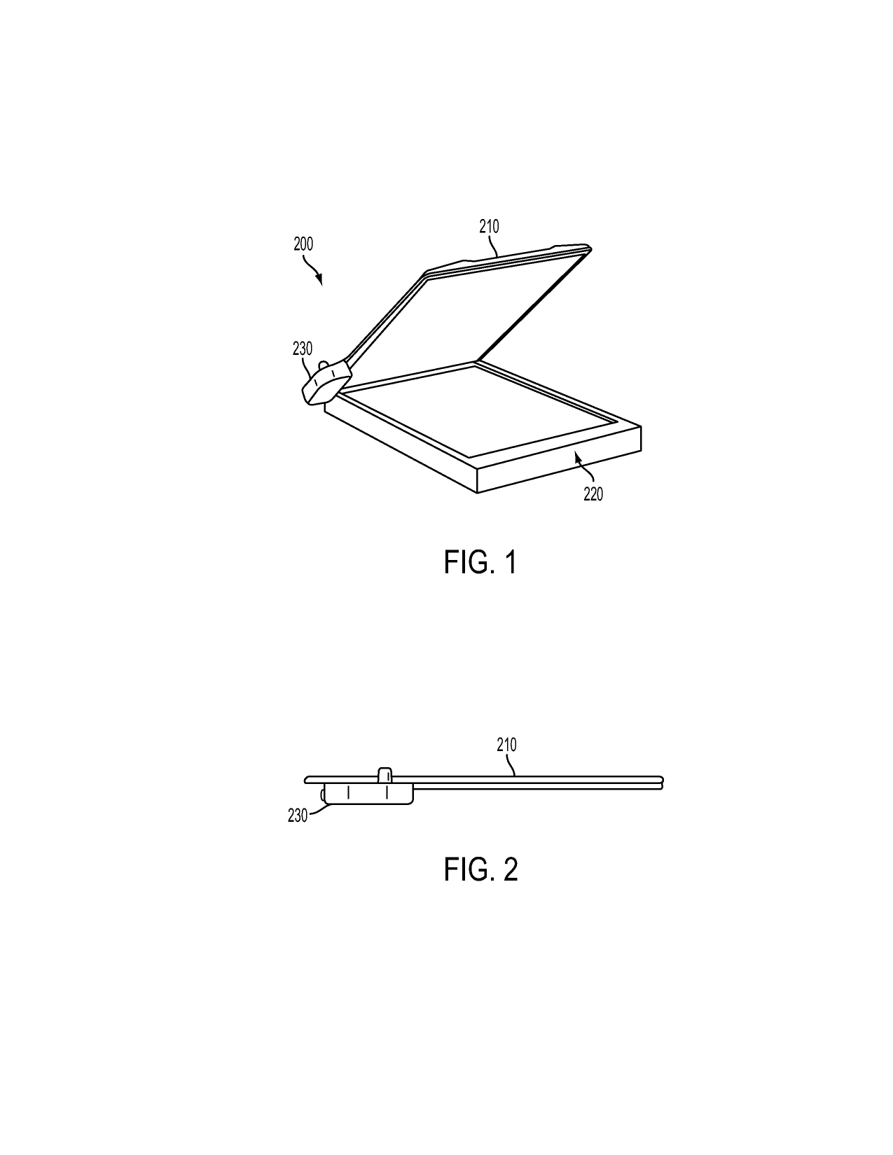

FIG. 1 shows a backlight assembly including an exposure control device and a light unit attached to a scanner in accordance with an embodiment of the present invention. Suitable light sources include those known in the art, including an LED light source.

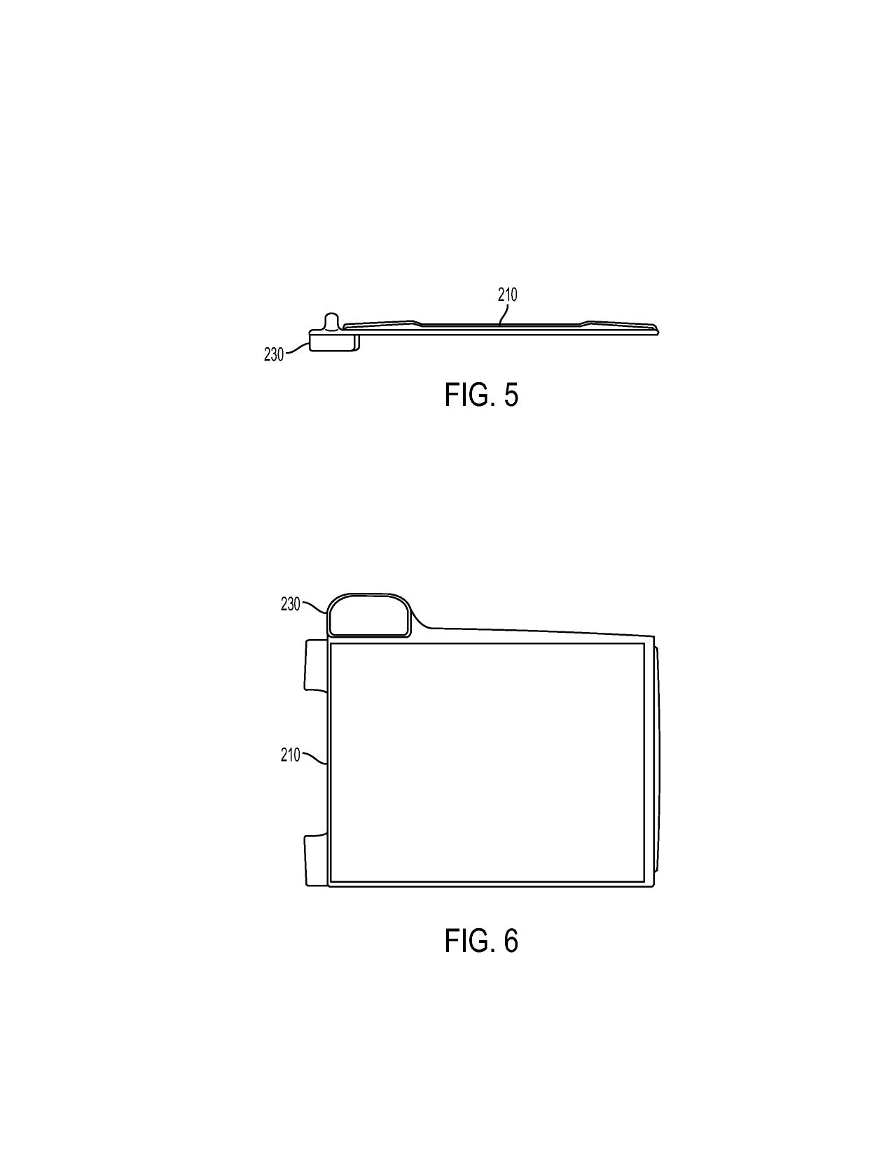

FIGS. 2, 4, 5 and 6 show a backlight assembly having an exposure control device in accordance with an embodiment of the present invention. The backlight assembly can be placed on or attached to a scanner suitable for backlit scanning of transmissive media.

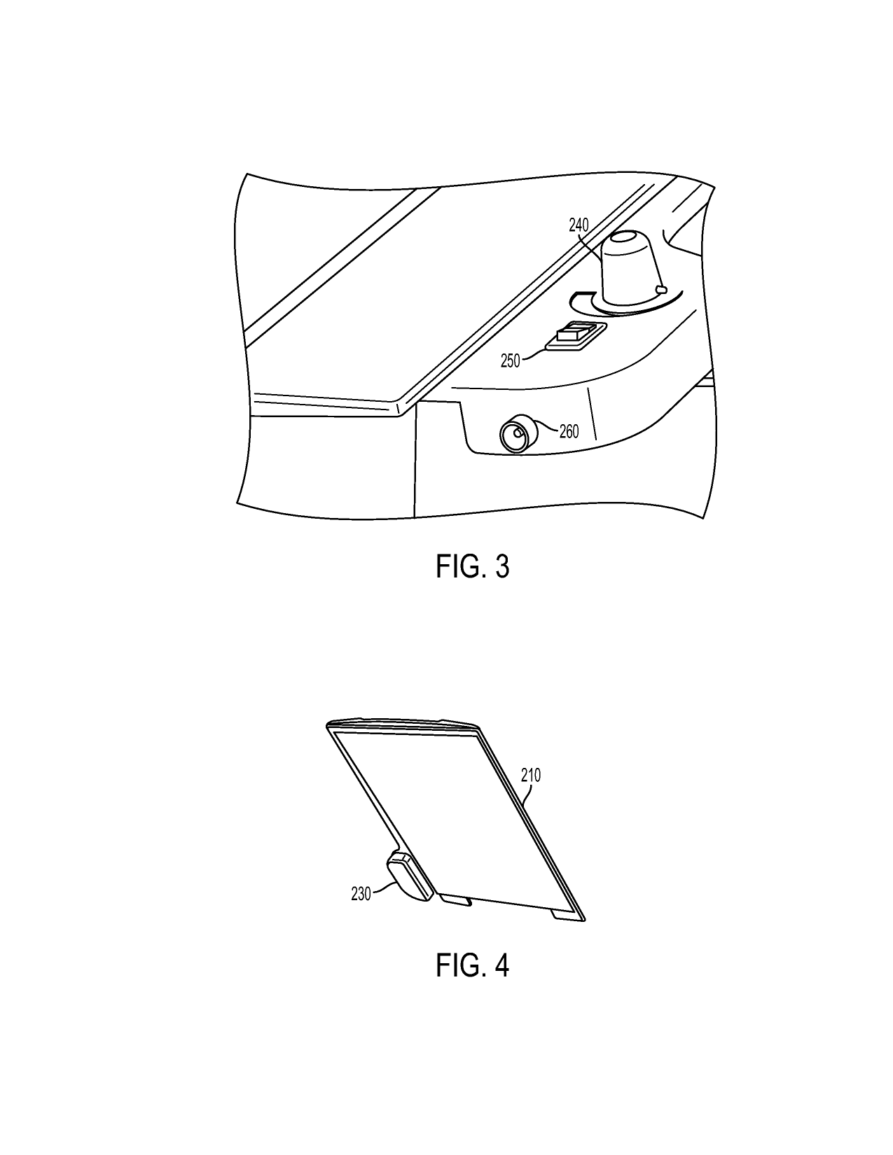

FIG. 3 shows an exposure control device of a backlight assembly in accordance with an embodiment of the present invention. Shown therein is an adjustment knob 240, on/off switch 250, and a plug 260 for an electrical power source. The exposure control device scanner shoots regular and sees the name of the patient in the scan with the x-ray film.

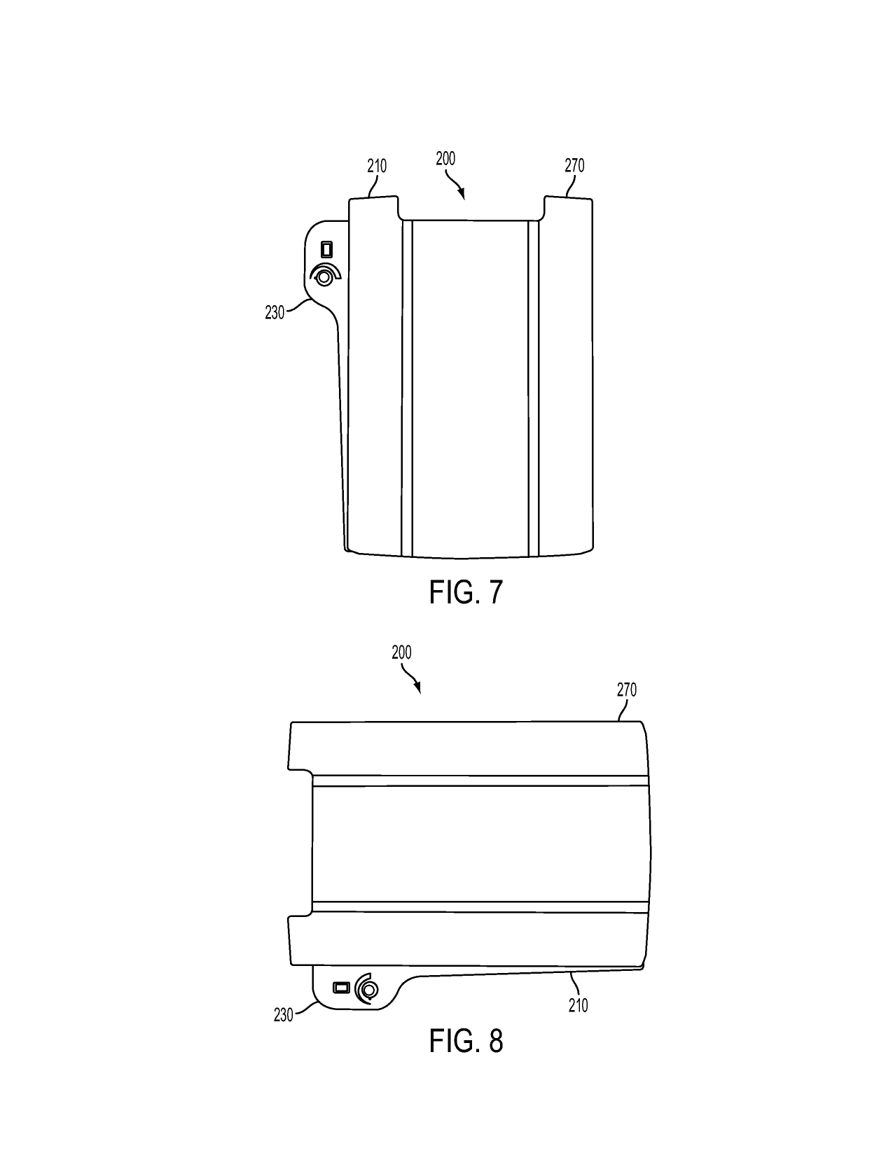

FIGS. 7 and 8 show the light unit with the exposure control device that sits on top of the scanner for a re-scan of the x-ray film to give a good image on the computer in accordance with an embodiment of the present invention. The exposure control is done by adjusting the resistance in the device to adjust the amount of light through the x-ray film to give a good image on the computer.

As shown in FIGS. 1 through 8, the backlit scanner includes a backlight assembly, and the backlight assembly includes: (i) an exposure control device; and (ii) a light source (LED light unit in FIGS. 1 through 6). In this embodiment the images are x-rays, but the present invention may be applied to scanning any sort of image medium that is designed to be suitably scanned by a backlit scanner. In this embodiment, the exposure control device includes a rheostat but other variable resistors can be used to control the exposure. In this embodiment, the scanner is a flat bed scanner, but this is not necessarily required of all embodiments.

### DEFINITIONS

Any and all published documents mentioned herein shall be considered to be incorporated by reference, in their respective entireties. The following definitions are provided for claim construction purposes:

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order, and the like).

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

Light: generally visible light, but to the extent that scanners (now or in the future) are made using other portions of the spectrum (for example, ultraviolet scanners) then those other portions of the electromagnetic spectrum shall be considered as “light” for purposes of the present invention; when it is necessary to exclusively denominate the visible light portion of the spectrum, then the term “visible light” will be used.

Unless otherwise explicitly provided in the claim language, steps in method or process claims need only be performed that they happen to be set forth in the claim only to the extent that impossibility or extreme feasibility problems dictate that the recited step order be used. This broad interpretation with respect to step order is to be used regardless of alternative time ordering (that is, time ordering of the claimed steps that is different than the order of recitation in the claim) is particularly mentioned or discussed in this document. Any step order discussed in the above specification, and/or based upon order of step recitation in a claim, shall be considered as required by a method claim only if: (i) the step order is explicitly set forth in the words of the method claim itself; and/or (ii) it would be substantially impossible to perform the method in a different order. Unless otherwise specified in the method claims themselves, steps may be performed simultaneously or in any sort of temporally overlapping manner. Also, when any sort of time ordering is explicitly set forth in a method claim, the time ordering claim language shall not be taken as an implicit limitation on whether claimed steps are immediately consecutive in time, or as an implicit limitation against intervening steps.

What is claimed is:

1. A backlit scanner system for scanning images printed on a transmissive medium, the scanner comprises:
a scanner to create an image based on light received from the transmissive medium when the transmissive medium is scanned; and
a backlight assembly positioned on the scanner to backlight the transmissive medium, the assembly comprising a light source and an exposure control device which enables the user to adjust the intensity of the light source to optimize the quality of the scanned image.

2. The scanner of claim 1, wherein the exposure control device comprises a rheostat.

3. The scanner of claim 1, wherein the light source comprises an LED.

4. A backlight assembly comprising a light source and an exposure control device which enables the user to adjust the intensity of the light source transmitted from the backlight assembly.

5. The scanner of claim 1, wherein the exposure control device comprises a rheostat.

6. The scanner of claim 1, wherein the light source comprises an LED.

7. A method of scanning an image on a transmissive medium comprising:
(a) providing a backlit scanner comprising a scanner to create an image based on light received from the transmissive medium when the transmissive medium is scanned; and
a backlight assembly positioned on the scanner to backlight the transmissive medium, the assembly comprising a light source and an exposure control device which enables the user to adjust the intensity of the light source to optimize the quality of the scanned image;
(b) placing a transmissive medium comprising an image in the scanner;
(c) performing a preliminary scan on the transmissive medium to obtain preliminary scanning results;
(d) subsequent to step (c), adjusting the exposure control device to control the amount of backlighting, in response to observed preliminary scanning results; and
(e) subsequent to step (d), performing a re-scan on the transmissive medium.

8. The method of claim 7, wherein the exposure control device comprises a rheostat.

9. The method of claim 7, wherein the light source comprises an LED.
